(19) United States
(12) Patent Application Publication
(10) Pub. No.: US 2024/0281753 A1
(43) Pub. Date: Aug. 22, 2024

(54) Machine Learning Technologies for Assessing and Classifying Shipping Facilities

(71) Applicant: PROJECT44, LLC, Chicago, IL (US)

(72) Inventors: Matthew George Dzugan, Forest Park, IL (US); James Laurence McElveen, Shiloh, IL (US)

(21) Appl. No.: 18/112,436

(22) Filed: Feb. 21, 2023

(51) Int. Cl. G06Q 10/083

(52) U.S. Cl. CPC G06Q 10/0838

(57) ABSTRACT

A method includes receiving and processing raw shipment data using machine learning models trained using historical shipment data to identify and classify terminal shipment locations. A system includes a memory storing a set of computer-readable instructions and historical shipment data; and one or more processors interfaced with the memory and configured to execute the set of computer-readable instructions to cause the one or more processors to: receive and process raw shipment data using machine learning models trained to identify and classify terminal shipment locations. A non-transitory computer-readable storage medium configured to store instructions executable by a computer processor, the instructions comprising: instructions for receiving and processing raw shipment data using machine learning models trained using the historical shipment data to identify and classify terminal shipment locations.

### FIELD

The present disclosure is directed to improvements related to predicting information related to shipping facilities. More particularly, the present disclosure is directed to platforms and technologies for using machine learning to analyze data associated with shipments of goods to identify and/or classify shipment locations from raw shipment data.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers (i.e., entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Currently, large volumes of data are generated that describe shipments of goods from one facility to another (e.g., from an origin facility such as a factory to a destination facility such as a distribution center (DC) facility, a warehouse facility, a retail facility, etc.). However, it is not possible to determine anything about the facilities merely by viewing these volumes of data. Conventional techniques may include scraping location data from business websites and using text analysis to attempt to determine a location type, but these conventional approaches are limited by the amount and quality of information available on business websites. None of the business websites are standardized, which further limits the usefulness of web scraping.

Overall, there is a lack of transparency and insight regarding the performance of origin and destination facilities in industry. For example, there is currently no way to determine what type of facility a given origin or destination shipment is, or to determine which facilities are more or less operationally efficient. For example, conventional comparisons between facilities lack granularity, and are limited to determining whether one given retailer (e.g., Walmart or Target) is generally more or less efficient than another, without any insight into the specific facilities that may be used to shuttle the respective retailers' goods from place to place. Therefore, there is no way for any industry participants to benchmark facility performance, or to provide anything approaching systematic analysis (and subsequent improvements).

Accordingly, there is an opportunity for platforms and technologies to leverage data sources and data analysis techniques to effectively and accurately identify classify facilities, to enable comparison of the facilities at a granular level, and to improve facility performance.

### SUMMARY

In an aspect, a computer-implemented method of using machine learning to improve automated shipping facility identification and classification by processing raw shipment data is provided. The method may include: (i) receiving, via one or more processors, the raw shipment data; (ii) processing the raw shipment data using a machine learning model trained using historical shipment data, wherein the processing includes identifying one or more shipment locations corresponding to the raw shipment data, each including a respective classification value; (iii) classifying each of the one or more terminal shipment locations using a second machine learning model trained using the historical shipment data to generate one or more facility classifications; and (iv) storing the one or more facility classifications and the one or more terminal shipment locations in a memory.

In another aspect, system for using machine learning for improved automated shipping facility identification and classification is provided. The system may include a memory storing a set of computer-readable instructions and historical shipment data; and one or more processors interfaced with the memory. The processors may be configured to execute the set of computer-readable instructions to cause the one or more processors to: (i) receive, via one or more processors, raw shipment data; (ii) process the raw shipment data using a first machine learning model trained using historical shipment data to identify one or more terminal shipment locations; (iii) classify each of the one or more terminal shipment locations using a second machine learning model trained using the historical shipment data to generate one or more facility classifications; and (iv) store the one or more facility classifications and the one or more terminal shipment locations in a memory.

Further, in an aspect, a non-transitory computer-readable storage medium configured to store instructions executable by a computer processor is provided. The instructions may include: (i) instructions for receiving, via one or more processors, raw shipment data; (ii) instructions for processing, using a first machine learning model trained using the historical shipment data, the raw shipment data to identify one or more terminal shipment locations corresponding to the raw shipment data; (iii) instructions for classifying, via one or more processors, each of the one or more terminal shipment locations using a second machine learning model trained using the historical shipment data to generate one or more facility classifications; and (iv) instructions for storing, via one or more processors, the one or more facility classifications and the one or more terminal shipment locations in a memory.

### BRIEF DESCRIPTION OF THE FIGURES

FIG. 1 illustrates an overview of a computing system, according to some aspects.

FIG. 2 depicts an exemplary deep learning artificial neural network (DNN) that may be employed by the systems and methods, in accordance with some aspects.

FIG. 3 depicts a signal diagram, according to some aspects.

FIG. 4A depicts an example graphical user interface of facility classification information, according to some aspects.

FIG. 4B depicts an example graphical user interface, according to some aspects.

FIG. 5 depicts a block diagram of an example method 500 of using machine learning to improve automated shipping facility identification and classification by processing raw shipment data, according to some aspects.

### DETAILED DESCRIPTION

### Overview

The present aspects may relate to, inter alia, analyzing various data associated with a particular product shipment using a machine learning model to classify one or more facilities associated with the product shipment. According to certain aspects, systems and methods may initially train the machine learning model using a set of training data and store the machine learning model in memory for subsequent use. The present techniques include classification techniques. For example, in some aspects, one or more machine learning models are trained to predict one or more classes based on input data using historical training examples. The present techniques include classifying shipping facility types (e.g., warehouse, distribution center, retail facility, etc.) and/or shipping locations (e.g., on the road, weight station, at port, rail yard, etc.). In some aspects, modeling techniques may be used to predict a facility/location type according to an activity carried out there (e.g., whether a retail location is a pharmacy). In general, the terms “classification,” “classification value,” may be used interchangeably to refer to model outputs corresponding to predictions of respective locations, location types, facilities, facility types, etc.

As indicated, in the following, a given “location” or “facility” may be terminal or non-terminal. For example, terminal locations may be those that are situated at either end of a shipment (e.g., an originating shipping facility or a destination shipping facility). Non-terminal locations or facilities may include weigh stations, nautical ports, truck stops, rest areas, etc. As discussed herein, the present techniques may include training machine learning models to identify one or more locations/facilities from within opaque shipping data (e.g., unstructured shipping data) and for classifying the identified locations/facilities. In some aspects, the classification may include binarily classifying the locations/facilities as terminal/non-terminal.

Subsequent to a shipping agreement for a set of products being reached between a shipper and a carrier, the systems and methods may interface with a set of data sources and receive various data associated with the shipment of the set of products and conditions related thereto, including raw shipment data. In some aspects, the received information may be labeled. For example, the present techniques may include training one or more machine learning models using training data that comprises a plurality of tuples of the form (label, shipping data) wherein the label corresponds to a facility type label (e.g., distribution center, retail center, etc.) and the shipping data corresponds to shipping data corresponding to shipments from facilities of that facility type. In some aspects, unlabeled data may be used for model training, such as when an unsupervised model is used to identify patterns in the shipping data.

For example, a first tuple may have a label “Amazon warehouse” and the shipping data may include one or more bills of lading for semitrailer truck shipments of goods from the Amazon warehouse to a local distribution hub, 300 miles away in the same state. Of course, many other types of training data may be used in addition to bills of lading, such as policies of insurance, invoices, waybills, etc. Less formal documents (e.g., emails) may be used for training in some aspects. The training data may be proprietary data of the operator of the present techniques in some aspects and may include originally electronic data and/or electronic documents of scanned paper documents. In some aspects, the training data may include publicly-available information. The systems and methods may input the received information into the machine learning model in order to train the machine learning model to learn to classify de novo inputs that the machine learning model has not previously seen.

As noted above, there is currently an abundance of big data being generated by shipping activities. However, there is very little transparency regarding the meaning of this data. Shipping is a highly vertically integrated industry, and one party has access to enough data across the entire landscape of industry participants (from shippers, to warehousers, to common carriers, to shipping service purchasers) to enable curation and training of models that can present a holistic view of shipping at scale. In practice, this means that industry participants are not able to determine the type of a given shipping facility based on data alone, or to take the next step of comparing one facility to another. The present techniques address these issues.

In some aspects, different models may be trained to perform different classifications. For example, a first model may be trained to determine a multi-class probability for input data. The multi-class probability may provide a plurality of classification outputs, each one corresponding to a respective probability that the input data corresponds to a particular facility type (e.g., a DC facility probability, a warehouse probability, a retail probability, etc.).

In some aspects, the systems and methods may be used to compare facilities (e.g., two or more DCs), and may enable a user (e.g., a customer, a shipper, a retailer, etc.) to access a dashboard or other interface that describes how a particular facility compares to others according to one or more criteria (e.g., loading times, unloading times, etc.).

In some aspects, the systems and methods may include unsupervised or supervised machine learning techniques for inferring information about facilities. For example, inbound shipment information, outbound shipment information may be analyzed to classify facilities. According to certain aspects, the systems and methods may perform the analyses without use of a machine learning model.

The systems and methods therefore offer numerous benefits. In particular, the systems and methods use machine learning or artificial intelligence techniques to effectively and accurately classify facilities, which enables the facilities to be compared, thus leading to the generation of useful metrics. Thus, the systems and methods enable customers (e.g., shippers, carriers, facilities owners/operators, etc.) to access and review whether their shipments are being handled effectively, and to root out inefficiencies. Additional benefits are envisioned.

The systems and methods represent an improvement to an existing technology or technologies, namely technologies for performing data mining of unstructured raw shipping data for the purpose of identifying structure and making sense and meaning of that structure. Technologies do not currently exist for gathering up shipping data from many of the different parties within the shipping ecosystem (e.g., from common carriers, to ocean liner operators, to trucking companies, to distribution center operators, to last mile shipment operators, etc.); processing that data using trained machine learning models to map out shipment locations (e.g., terminal locations) and to classify said locations according to the facility type at a generic and/or more granular level.

Further, technologies do not exist for storing the data processed and classified using machine learning, and for performing further analytical functions on that data. For example, there is currently great consternation in the shipping industry for shippers that there is no easy way to compare shipping providers, even to answer basic questions regarding efficiencies. There is also great frustration caused by the fact that reputation among industry participants is subjective, leading to some shipping providers being considered “good” partners while others are, in fact, less efficient or profitable. By systematizing the process of analyzing unstructured shipping data, and enabling comparisons between industry participants to be made on an objective basis, the present techniques improve methods and systems for comparing shipping industry participants (e.g., distribution center operators, railroad carriers, freight carriers, ocean carriers, etc.).

Thus, the present techniques provide new solutions and improve upon existing solutions in multiple ways, positively affecting the capabilities of shipping industry participants and customers alike. These improvements lead to increased quality of service, by enabling market participants to base their judgments and purchase/sale decisions on real data instead of guesses or anecdotes. A more efficient shipping market that has improved allocation of capital leads to fewer trucks on the road, less idling of vehicles of all types, and thus, less pollution/contaminants and more efficient usage of existing resources.

The systems and methods discussed herein address a business challenge, namely that while voluminous data is generated by modern shipping and logistics systems, that data does not include information sufficient to allow anyone to compare loading/unloading times between logistic service providers, DC operators, etc. In conventional platforms, shipment data is available, but cannot be used to analyze shipment performance due to the facilities information being completely opaque. In contrast, the systems and methods are able to ingest or access data from multiple data sources and analyze that data to provide rich classifications of facilities according to facility type, providing a far more granular view, and enabling comparisons across many dimensions, thus enabling multiple interested parties in the shipping industry to evaluate and enhance facility performance and operations.

Therefore, the systems and methods do not merely recite the performance of some business practice known from the pre-Internet world (tracking a shipment) along with the requirement to perform it on the Internet. Instead, the systems and methods incorporate computer networks that enable communications among shipper entities, carrier entities, and data sources such as electronic logging devices, among other entities and components. Thus, the systems and methods are necessarily rooted in computer technology in order to overcome a problem specifically arising in logistics technologies.

According to implementations, the systems and methods may support a dynamic, real-time or near-real-time collection, analysis, and communication of any data that may be associated with conditions related to the shipment of goods. In particular, the systems and methods may dynamically and automatically access or retrieve data indicative of operational conditions such as vehicle locations, analyze the data, and determine shipping conditions and updates. In these ways, the systems and methods discussed herein address technical challenges, namely establishing dynamic data collection, analysis, and communication across dedicated computer systems, including different systems for different carrier entities and shipper entities.

### Exemplary Computing Environment

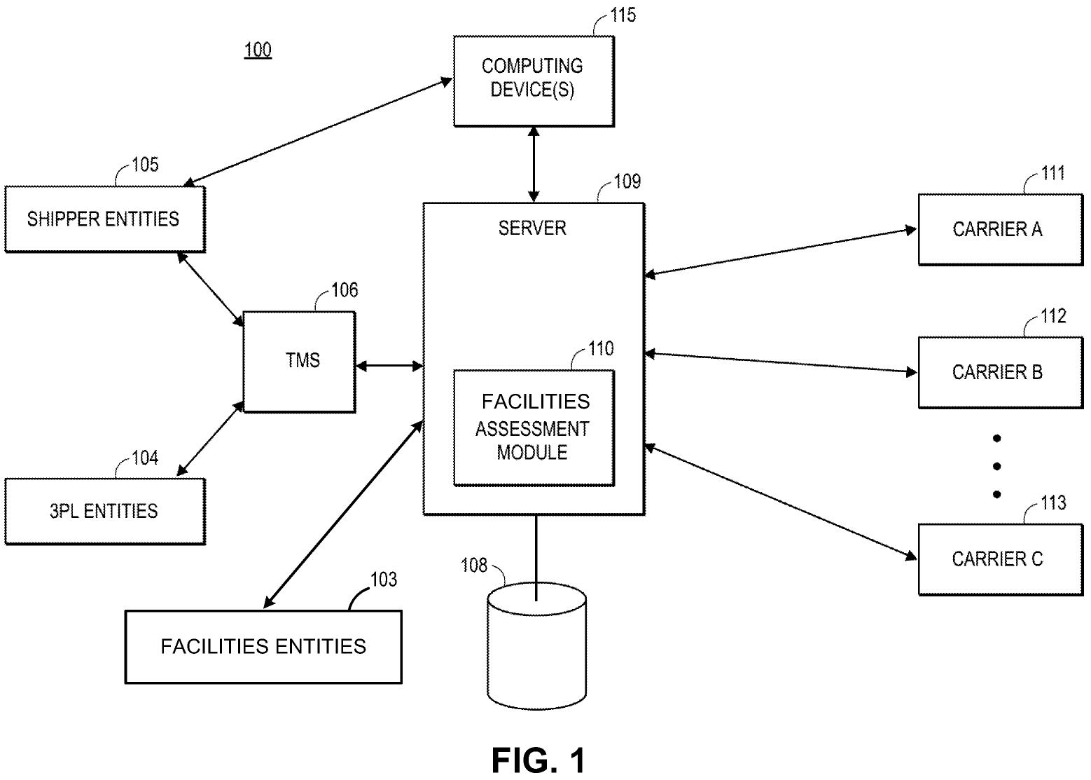

FIG. 1 illustrates an overview of a system 100 of components configured to facilitate the systems and methods, according to some aspects. The system 100 is merely exemplary and that alternative or additional components are envisioned.

As illustrated in FIG. 1, the system 100 includes a set of facilities entities 103, a set of shipper entities 105 and a set of 3PL entities 104.

Each of the facilities entities 103 may be a company, corporation, business, entity, individual, group of individuals and/or the like that may own, operate and/or manage a facility (e.g., a shipment origin and/or destination, whether intermediate or final). A “facility” herein may refer to any physical space through which goods transit and/or are stored even if only temporarily during the shipment of goods, such as a warehouse, a retail store, a distribution center, a storage facility, a parking lot, a dock, a port, an airport, a train yard, a terminal, a weighing station, etc.

Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. Various amounts of the shipper entities 105 are envisioned. In some instances, the shipper entities 105 may be facilities entities 103, and vice versa.

Each of the 3PL entities 104 may be a third-party provider that the set of shipper entities 105 may use to outsource certain elements associated with handling and managing the transportation of the physical goods. In some aspects, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). Various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to aspects, the transportation of goods may be accomplished via marine or water (i.e., using boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to aspects, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to aspects, the TMS 106 may support specific and particular communication capabilities with the other entities of the system 100. In particular, the TMS 106 may support communication with the other entities via different components and protocols.

As illustrated in FIG. 1, the system 100 may include a server 109 that may interface and communicate with at least the TMS 106, the set of carrier entities 111, 112, 113, and a set of computing devices 115. The server 109 may include any combination or hardware and software components and may be associated with any type of entity or individual. The server 109 may support execution of a facilities assessment module 110. According to aspects, the facilities assessment module 110 may receive various data associated with a shipment and determine, by inputting at least the various data into a machine learning model, one or more identifications and/or classifications with respect to facilities included in the various data, as discussed below. The facilities assessment module 110 may interface with a database 108 or other type of memory configured to store data accessible by the facilities assessment module 110.

The set of computing devices 115 may enable users access to a dashboard, interface, or the like that may include classifications of various shipping data, as determined by the facilities assessment module 110. In aspects, the set of computing devices 115 may be associated with one or more of the shipper entities 105. Accordingly, the set of computing devices 115 may interface with the server 109 and/or the shipper entities 105.

Although FIG. 1 depicts the server 109 in communication with the TMS 106 and the set of carrier entities 111, 112, 113, alternative configurations are envisioned. In one particular implementation, the TMS 106, the 3PL entity 104, and the server 109 may be combined as a single entity (i.e., the server 109 may communicate directly with the shipper entities 105, the facilities entities 103 and/or the set of carrier entities 111, 112, 113). In another implementation, either the TMS 106 or the 3PL entity 104 may be combined with the server 109 as a single entity capable of performing the respective functionalities.

Although not depicted in FIG. 1, the server 109 may support one or more computer networks that may enable communication between and among the entities and components of the server 109. In aspects, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the agreement assessment module 110) via an Internet connection.

Generally, a shipper entity 105 ships one or more shipments using one of the carriers 111-113. Along the way, the shipment may visit one or more facilities of the facilities entities 103. The shipper, carriers and/or facilities entities may contract with one another to facilitate the loading, transportation, storage and/or unloading of freight or other goods.

In some situations, a shipping agreement may be reached between a first shipper entity and a second shipper entity, or between a carrier entity and multiple shipper entities. For example, the second shipper entity may purchase a set of products, and the first shipper entity may contract with a 3PL entity to transport, load and/or unload the set of products for delivery to the second shipper entity. Therefore, a shipping agreement need not be reached between a shipper entity and a carrier entity but may alternatively be reached between a shipper entity and another shipper entity (or between a carrier entity and multiple shipper entities). It should also be understood that any party to a shipping agreement may interface with the facilities assessment module 110 and access data resulting therefrom.

The components and entities of the server 109 may include and support various combinations of hardware and software components capable of facilitating various of the functionalities of the systems and methods. For example, the components and entities of the server 109 may generally support one or more computer processors, communication modules (e.g., transceivers), memories, and/or other components.

The system 100 may be implemented on any computing device or combination of computing devices, including the server 109. Components of computing device(s) may include, but are not limited to, a processing unit (e.g., one or more processors), a system memory, and a system bus that couples various system components including the memory to the processor(s). In some aspects, the processor(s) may include one or more parallel processing units capable of processing data in parallel with one another. The system bus may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

In some aspects, the system 100 may further include one or more a user interfaces configured to present content (e.g., input data, output data, processing data, and/or other information). Additionally, a user may review results of raw shipping data identification/classification machine learning processing output and make selections to the presented content via the user interface, such as to review output data presented thereon, make selections, and/or perform other interactions. The one or more user interfaces may be embodied as part of a touchscreen configured to sense touch interactions and gestures by the user. Although not shown, other system components communicatively coupled to the system bus may include input devices such as cursor control device (e.g., a mouse, trackball, touch pad, etc.) and keyboard (not shown). A monitor or other type of display device may also be connected to the system bus via an interface, such as a video interface. In addition to the monitor, computers may also include other peripheral output devices such as a printer, which may be connected through an output peripheral interface (not shown).

The memory may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a shipping data processing application) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor of the computing devices.

The server 109 may operate in a networked environment and communicate with one or more remote platforms, such as an API (not depicted), via an electronic network(s), such as a local area network (LAN), a wide area network (WAN), or other suitable network(s). The system 100 may be implemented on any computing device(s) In some aspects, one or more applications as will be further described herein may be stored and executed remote from the server 109.

Generally, data input into and output from the server 109 may be embodied as any type of electronic document, file, template, etc., that may include various graphical/visual and/or textual content, and may be stored in memory as program data in a hard disk drive, magnetic disk and/or optical disk drive in the server and/or in remote computing devices. The server 109 may support one or more techniques, algorithms, or the like for analyzing input data to generate output data. In particular, the facilities assessment module 110 may process various types and forms of raw shipment data and other parameters associated with a shipment of goods to identify one or more locations within the raw shipment data, and one or more respective classifications for each of the identified locations. Based on the analysis, the facilities assessment module 110 may output data that indicating the identified locations and/or classifications. Additionally, the facilities assessment module 110 may store the output data and other data that the server 109 generates or uses.

According to aspects, the facilities assessment module 110 may employ machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data is a training dataset, the facilities assessment module 110 analyze/process the input data to generate a machine learning model(s) for storage as part of model data that may be stored in the memory of the server and/or in the database 180.

When the input data comprises various tracking, inventory, and/or shipping raw data associated with a shipment to be processed using the trained machine learning model, the facilities assessment module 110 may analyze or process the input data using the trained machine learning model to generate one or more identifications of shipping locations/facilities within the raw shipment data, including respective classifications. The identifications and classifications output by the machine learning model may include confidence values reflecting the confidence of the machine learning model that the identifications and/or classifications are correct. Any of the input data (e.g., shipment raw data, training data, etc.) and output data (e.g., identifications, classifications, etc.) may be stored in the memory.

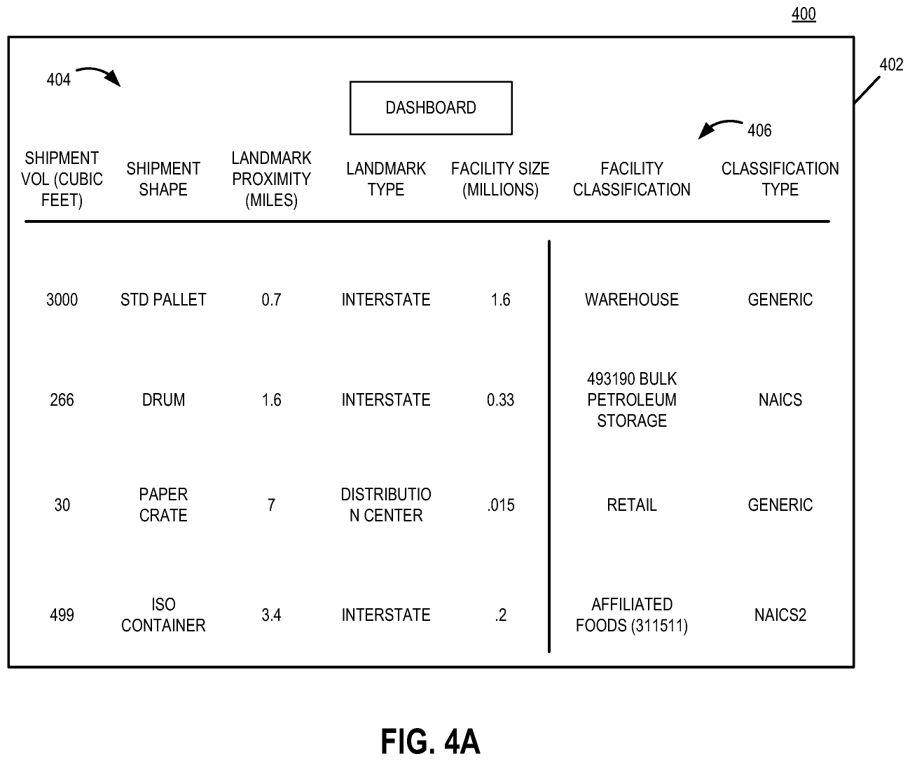

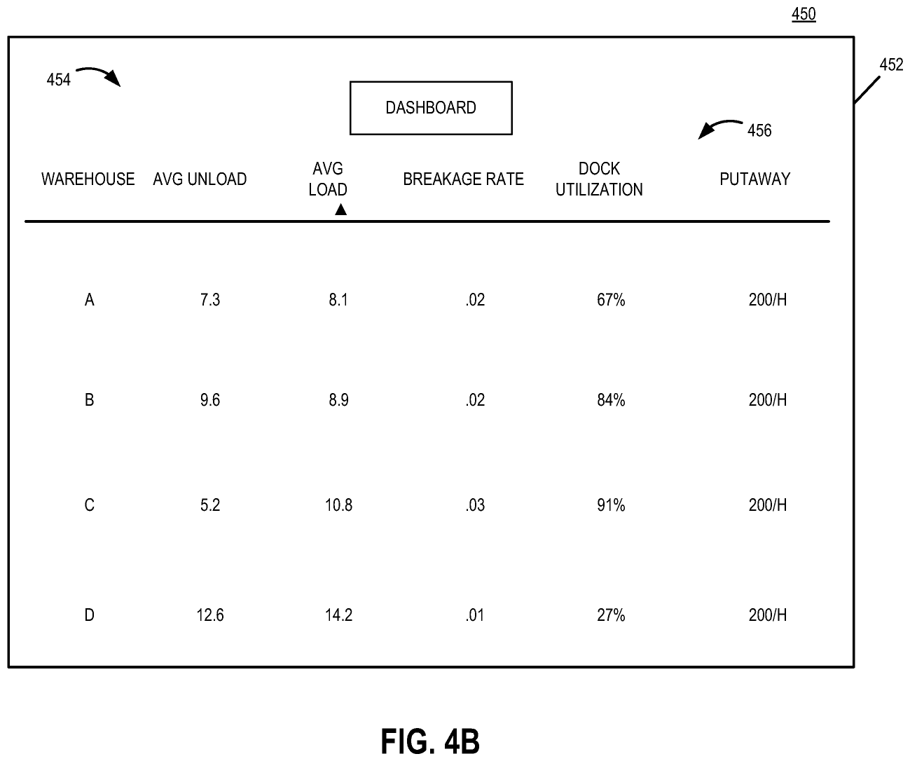

The facilities assessment module 110 (or another component) may cause the output data (and, in some cases, the training or input data) to be displayed on one or more user interfaces for review by the user of the server 109, as shown in FIG. 4A.

In general, a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, ActionScript, Objective-C, JavaScript, CSS, XML, R, Stata, AI libraries). In some aspects, the computer program product may be part of a cloud network of resources. In some aspects, machine learning frameworks may be used to accelerate development and testing of the machine learning models (e.g., scikit-learn, hugging face, spaCy, TensorFlow, etc.).

### Exemplary Artificial Neural Network

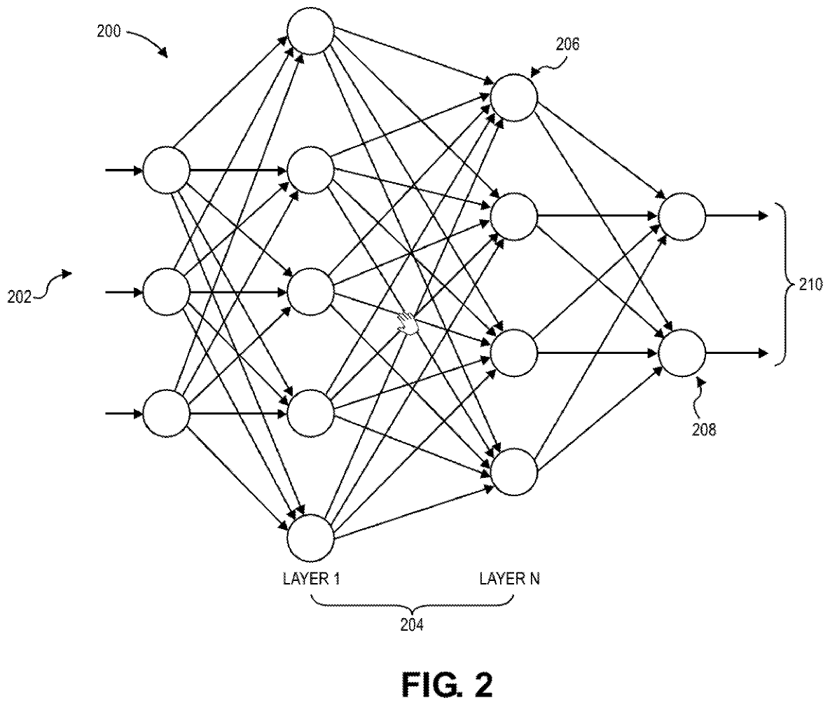

FIG. 2 depicts an exemplary deep learning artificial neural network (DNN) 200, which may be used in conjunction with the machine learning techniques as discussed herein. The DNN 200 may be trained and/or operated by the facilities assessment module 110 of FIG. 1B, for example. The DNN 200 may include a plurality of layers, each of which may include any number of respective neurons, or nodes.

The DNN 200 may include an input layer 202, one or more hidden layers 204, and an output layer 208. Each of the layers in the DNN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of DNNs are possible.

The input layer 302 may correspond to a large number of input parameters (e.g., one million inputs), in some aspects, and may be processed serially or in parallel. Further, various neurons and/or neuron connections within the DNN may be initialized with any number of weights and/or other training parameters. Each of the neurons in the hidden layers 204 may process one or more of the input parameters from the input layer 202, and/or one or more outputs from a previous one or more of the hidden layers 204, to generate a decision 210 or other output. The output layer 208 may generate the decision 210 or more outputs, each indicating a prediction or an expected value. The number of input neurons may be stored as a predetermined value, and used to initialize a network for training.

In some aspects and/or scenarios, the output layer 208 may include only a single output 210. For example, a neuron may correspond to one of the neurons in a hidden layer 206. Each of the inputs to the neuron may be weighted according to a set of weights W1 through Wi, determined during the training process (for example, if the neural network is a recurrent neural network) and then applied to a node that performs an operation α. The operation α may include computing a sum, a difference, a multiple, or a different operation. In some aspects weights are not determined for some inputs. In some aspects, neurons of weight below a threshold value may be discarded/ignored. The sum of the weighted inputs, r1, may be input to a function which may represent any suitable functional operation on r1. The output of the function may be provided to a number of neurons of a previous/subsequent layer or as an output 210 of the DNN. In some aspects, the DNN may include one or more convolutional neural network (CNN) layers.

### Exemplary Signal Diagram

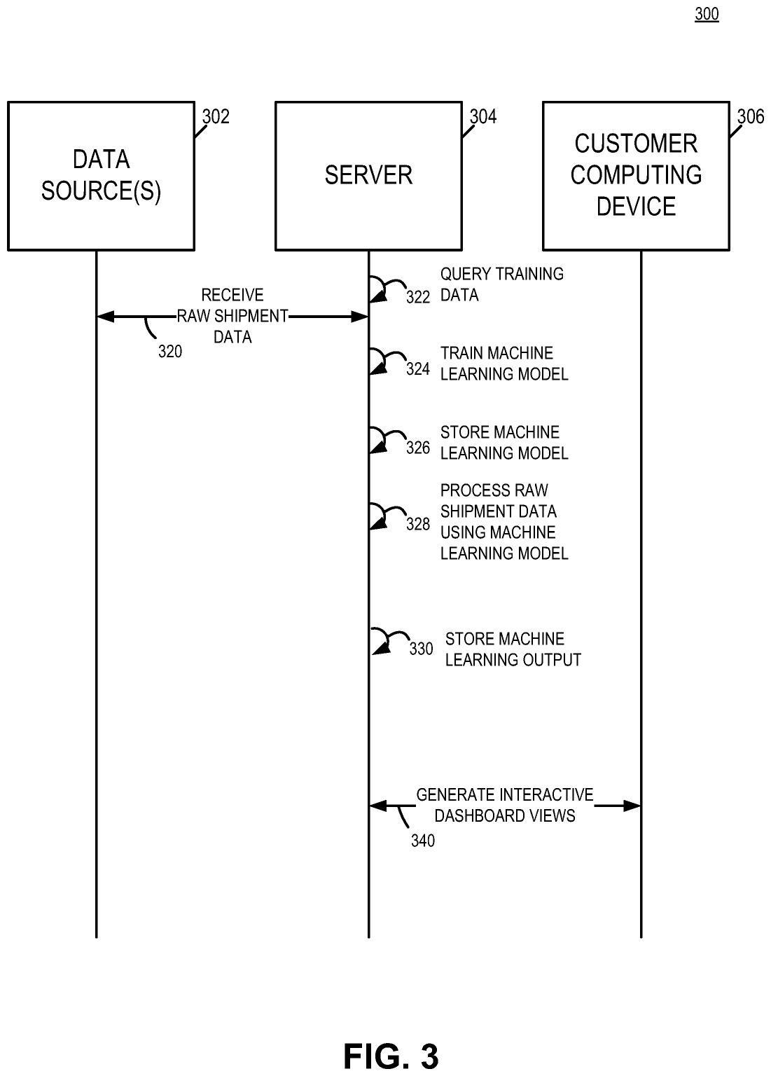

FIG. 3 depicts a signal diagram 300 with various functionalities associated with the described aspects. The signal diagram 300 includes one or more data sources 302, a server 304, and a customer computing device 306. According to aspects, the data source(s) 302 may be associated with one or more shipper entities, one or more carrier entities, one or more transportation management systems, and/or other data vendors. Further, the server 304 may correspond to, for example, the server 109 as described with respect to FIG. 1 and may implement the facilities assessment module 110 as discussed with respect to FIG. 1. Additionally, the customer computing device 306 may correspond to, for example, the computing device 115 as discussed with respect to FIG. 1 and may be associated with a shipper entity (or another interested party). Generally, the shipper entity associated with the computing device 115 may reach a shipping agreement with a carrier entity to transport goods or products associated with an order.

Although the signal diagram 300 is described as employing artificial intelligence and machine learning to implement and facilitate various of the functionalities, the signal diagram 300 may operate without artificial intelligence or machine learning. In this regard, the signal diagram 300 may access inventory, tracking, and/or raw shipping information from the data source(s) 302 and perform calculations on the information or data to determine relevant output data.

The signal diagram 300 may start with the server 304 querying (322) training data from the one or more data sources 302 (e.g., via a database, flat file, memory, or other storage), prior to or after receiving (320) raw shipment data. In particular, the server 309 may access a set of training data including raw shipment data. In some aspects, the raw shipment data may include training labels or other metadata that the machine learning model uses to learn to perform one or more location identifications/classifications as discussed herein.

In some aspects, the server 304 may receive raw shipment data from one or more vehicles. Specifically, one or more vehicles (a truck, a ship, a train, an unmanned aerial vehicle, etc.) may include a global positioning service (GPS) transceiver capable of transmitting precise location data to the server 304. Therefore, the signal diagram 300 may depict a process that in some aspects occurs during the transit of goods to a final destination. In other words, the present techniques may be used to discover/classify information pertaining to shipment locations while those shipments are still in progress, in some aspects.

The server 304 may use the received raw shipment data to train (324) one or more machine learning models. Generally, the set of training data may include information indicating shipments of goods and the initiation, shipment, and delivery of the products specified therein, including data regarding shipping and storage facilities, and may include real-world data and/or simulated, labeled data. According to aspects, the set of training data may include any combination of data corresponding to (i) a warehouse facility, (ii) a retail facility, (iii) a weigh station, (iv) a harbor facility or (v) a rail yard facility. The training data may include at least one of an origin facility identifier, a destination facility identifier, a waypoint facility identifier, a facility materials identifier, a facility square footage size, an address, a latitude/longitude pair, a carrier identifier, a shipment count, a shipment size, a shipment shape, a shipment volume, a timestamp, geospatial data, facility building data, zoning data, landmark proximity data, electronic logging device data, GPS data, and/or vehicle identifier data. It should be appreciated that the server 309 may train the machine learning model using any combination of one or more techniques, calculations, or the like.

Generally, a given raw shipment data may relate to one or more shipments of goods, items, or products and may include data related to a shipper entity and a carrier entity, including data related to delivery of and payment for the shipment(s). Further, the raw shipment data may include associated dates, including an order submission date, a supplier ready date, and an original or intended due date. The raw shipment data may be arranged as a time series or sequence of events, from shipment order to packaging at a warehouse or other facility, to one or more intermediate stop (including intermediate offloading/loading of goods in the shipment) at one or more waypoints, and destination data. Additional or alternative shipment raw data is envisioned. Further, a customer (e.g., a shipper entity) may specify or define certain shipment data.

Further, shipment raw data may be segmented into one or more sub-shipments (i.e., a first shipment may be for a first subset of the product(s) in the shipment, and a second shipment may be for a second subset of the product(s) in the shipping). Therefore, the shipment raw data may include a partial shipment or a full shipment. Further, shipment raw data may include data for a single leg shipment (i.e., directly from an origin to a destination), or a multi-leg shipment (i.e., from an origin to a destination via at least one intermediate stop). Additionally, a shipment may be single mode (i.e., transported from an origin to a destination using a single mode of transportation) or multimodal (i.e., transported from an origin to a destination using multiple modes of transportation).

According to aspects, the raw shipment data may indicate, for each shipment associated with a given shipping agreement, whether that shipment is early, late, or on-time, and may additionally indicate an estimated time of arrive (ETA) for that shipment. The server 309 may store (326) the machine learning model, for example in the database 108 or the memory as discussed with respect to FIG. 1.

Once the server 304 has trained the one or more machine learning model(s), the server 304 may process (328) raw shipment data as-yet unseen by the trained machine learning model(s) using the trained machine learning models to identify and/or classify one or more shipping locations. As discussed herein, the identification and/or classification may include generating a list of one or more facilities and a corresponding facility type.

The machine learning models may be configured to output a facility type that is a generic facility type (e.g., warehouse location, retail location, etc.) or a more specific/unique facility type (e.g., a facility type identified by a NAICS code, a specific location, such as an absolute address of a facility, etc.).

Further, the raw shipment data may indicate (or the server 309 may determine) whether the raw shipment data includes data corresponding to into partial shipments, and/or whether each shipment is a single or multi leg shipment, and/or whether each shipment is a single or multimodal shipment. For example, the raw shipment data may be divided into two partial shipments, the first shipment being a single leg shipment by truck, and the second shipment being a multi leg shipment initially completed by a ship and then by a truck.

As noted, according to aspects, the raw shipment data may include real-time tracking data for vehicles that are transporting the products, such as from electronic logging devices or location modules integrated within the vehicles. Thus, the server 309 may derive from the raw shipment data and for each shipment associated with raw shipment data, whether the shipment is early, late, or on-time, as well as an estimated time of arrive (ETA) for that shipment. Additionally, the server 309 may determine point-to-point average lead times for each shipment which the server 309 may use to determine the expected transmit time for that shipment.

Further, the server 309 may infer information regarding shipping facilities by comparing a plurality of shipping locations identified in the raw shipment data. For example, a comparison may include ranking a plurality of identified and classified shipping warehouses according to unloading speed, loading speed, damage, etc. According to aspects, the data received in (320) may indicate an inventory of the products being transported by a given vehicle.

Returning to the machine learning processing at (328), the server 309 may process the information provided in (320) using the machine learning model. In particular, the server 309 may input, into the machine learning model, at least a portion of the information provided in (320), which may include any combination of raw shipment data and information relating to one or more locations (e.g., landmark proximity data, location size data, etc.) and/or other information.

Generally, the analysis of the machine learning model may identify one or more shipping locations and/or one or more classifications each corresponding to a respective location. For example, in some aspects, the classifications may be binary classifications (warehouse/not warehouse), or multiclass classifications, wherein the machine learning model outputs a respective confidence value for a multitude of individual possible locations (e.g., a confidence value for warehouse, a confidence value for retail store, a confidence value for waypoint, etc.). In some aspects, the present techniques may use unsupervised learning to cluster the raw shipment data, in order to discover patterns in the data that are not predetermined. For example, the machine learning model may be trained to identify a new classification(s) that does not correspond to a predetermined type.

Any thresholds may be default values or specified by a user or administrator (e.g., an individual associated with a shipper entity. For example, a given classification confidence value may be deemed a positive classification if at or above 98.6%. The server 309 may perform the machine learning model analysis on a continuous basis as additional data (e.g., the data received in (320)) is provided, including on a real-time basis, as discussed above.

The server 309 may store (330) the output from the machine learning model, for example in the database 108 of FIG. 1 and/or in a memory of the server 309, and/or in a remote memory (e.g., in the memory of a remote computing device).

According to aspects, the server 309 may generate (340) interactive dashboard views. For example, the server 309 may generate web pages including identification and/or classification outputs based on the output, and may update an associated dashboard, account, interface, or the like, as depicted in FIG. 4B, for example. For a further example, if the machine learning model output included three identified locations, and a respective location classification for each one, with high confidence, then the output may display three rows on a dashboard for review or follow up by a user, as shown in FIG. 4A below.

Similarly, a dashboard may be divided into different sections, each one having a different confidence range. For example, a “red” section may include classifications a less than 50% confidence value, a “yellow” section may include classifications with a 50%-80% confidence value, and a “green” section may include classifications with greater than 80% confidence.

In this regard, users may review the dashboard to assess which locations have been identified and classified, and which may need to be followed up on or need some type of manual, automatic, or dynamic intervention. For example, if a given classification has a less than 50% confidence value, the server 309 may be configured to automatically receive additional raw shipment data from one or more vehicles or vessels known to be servicing that location. The confidence thresholds, dashboard information, communication content and transmission, and other information and functionalities are automatically defined or configurable by a user.

The server 309 may be configured to generate any type of notification, electronic message (e.g., email), or the like in association with processing the output from the machine learning model. Additionally, the server 309 may transmit or communicate the notification or message via any type of electronic delivery medium, network, or the like. Further, the notification or message may include various graphical or textual content for the associated user to review.

The server 309 may update the machine learning model based on the analysis of the data and output resulting therefrom. In this regard, the machine learning model may be continuously updated as new data is received and analyzed.

### Exemplary Graphical User Interfaces

FIG. 4A depicts an example graphical user interface 400 of facility classification information, according to some aspects. A user associated with an interested party (e.g., a shipper, a receiver, a warehouse manager, a 3PL entity, etc.) may use a computing device to review the interface 400 and assess various classifications corresponding to shipments. Additionally, a server (e.g., the server 109) may generate or determine the information included in the interface 400, as discussed herein. The interface 400 is merely an example, and that additional or alternative information is envisioned such as, for example, carrier identification, vehicle(s) identification, current location(s) of the vehicle(s), and/or other information.

The interface 400 depicts a window 402 including a plurality of rows of raw shipment data 404, wherein each row includes a plurality of raw shipment data values and corresponding respective classifications 406 of that raw data. The classifications 406 may have been generated using the trained machine learning techniques discussed herein.

For example, the present techniques may include multiple different modes of trained classification models. The classifications 406 may be directly output by one or more trained classification models. For example, a first model may be configured to predict generic classification types (e.g., “WAREHOUSE” or “RETAIL”) when provided with shipping data input. In some aspects, a second model may be configured to predict a more specific classification type, such as a NAICS model trained to classify a facility into one or more NAICS facility types. In some aspects, a third model may be configured to predict another specific classification type, such as one or more NAICS2 facility types. In still further aspects, a generic prediction model and one or more specific prediction models may be combined into a single classification pipeline that receives input shipping data and provides multiple classifications, wherein each includes a respective confidence value corresponding to the model's certainty that the input data corresponds to one or more given generic and/or specific classes. For example, with respect to the depicted example of FIG. 4A, a model pipeline may output the following: ({‘warehouse’:0.4, ‘NAICS-439190’:0.02, ‘RETAIL’: 0.0001, ‘NAICS2-311511’: 0.0006}). These examples are for explanation purposes only. Real-world/production examples may include many more (e.g., thousands or more) of respective classes, facility type classifications, and/or classification types. The raw shipment data values shown are exemplary in nature, and other values may be included, depending on how the machine learning model(s) are configured and trained. The classifications 406 may include a facility classification according to predefined generic categories (e.g., warehouse, retail, etc.) or specific classifications including NAICS categories and/or specific business identifiers, or other NAICS/NAICS2 information. Categorization systems other than NAICS/NAICS2 may be used, in some aspects, by adjusting the training of the machine learning model(s).

The user may review the interface 400 to ascertain the classification of different shipments. For example, the second row indicates that the shipment includes drums of bulk petroleum. The fourth row indicates that the shipment includes ISO containers from a particular business facility. In some aspects, confidence values may be displayed, as discussed.

FIG. 4B depicts an example graphical user interface 450, according to some aspects. The interface 450 includes a window 452 including a plurality of rows of facilities 454, wherein the rows are sortable according to various criteria by, for example, the user clicking a header row 456. In the depicted example, the user has chosen to sort by the AVG LOAD column, in ascending order. The facilities in the interface 450 may have been identified and classified using the machine learning techniques discussed herein. Using the interface 450, the user may compare various attributes (i.e., key performance indicators) of the respective facilities. Exemplary attributes are shown, but many others are envisioned. In some aspects, the user may filter the rows by typing one or more filter criteria into a filtering input element (not shown).

The present techniques represent an advantageous improvement, in that they not only identify and classify information previously locked up in opaque raw shipment data files, but also, provide users with the means to granularly and easily compare such information.

### Exemplary Computer-Implemented Methods

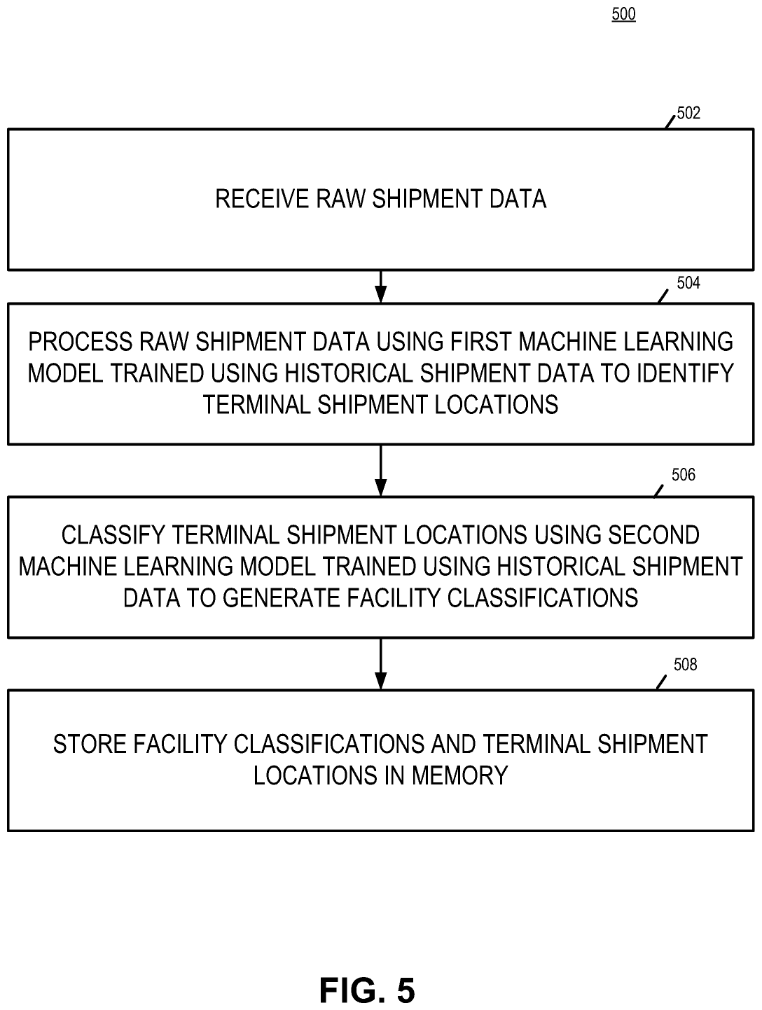

FIG. 5 depicts a block diagram of an example method 500 of using machine learning to improve automated shipping facility identification and classification by processing raw shipment data, according to some aspects. The method 500 may be facilitated by an electronic device (such as the server 109 as depicted in FIG. 1). In aspects, the electronic device may communicate with a set of data sources and a set of computing devices. As discussed herein, the electronic device may execute or facilitate the method 500 without training or using a machine learning model, and instead access/receive data and analyze the data to generate output data.

The method 500 may include receiving, via one or more processors, raw shipment data (block 502). “Raw shipment data” for purposes of the present techniques may include any information generated during shipment of goods from one place to another, and may include, for example, invoices, itineraries, bills of lading, electronic messages, tracking numbers, etc.

The method 500 may include processing the raw shipment data using a first machine learning model trained using historical shipment data (block 504).

In some aspects, the method 500 may include identifying one or more shipment locations corresponding to the raw shipment data, each including a respective classification value (e.g., one or more facility classifications). For example, a shipment location may be any identifiable geographic location, such as an absolute geographic position (e.g. a physical street address, a latitude/longitude), etc. In some aspects, the shipment location may be a terminal location (i.e., the beginning or ending location of a shipment).

The method 500 may further include classifying, via one or more processors, each of the one or more shipment locations using a second machine learning model trained using the historical shipment data to generate one or more facility classifications (block 506). The method 600 may store the one or more facility classifications and/or the one or more terminal shipment locations in a memory (block 508). The respective classification value (i.e., the one or more facility classifications) may be a categorical or descriptive identifier of the location (e.g., “retail shop,” “distribution center”, “warehouse,” “rail yard” etc.).

In some aspects, the method 500 may include receiving real-time data from one or more vehicles. For purposes of the present techniques, receiving data in “real-time” refers to receiving data during a time in which the vehicle is being operated (e.g., a ship is being sailed, leaving/entering port, etc.; or a delivery truck is being driven, a train is being operated, etc.).

In some aspects, the method 500 may include training the machine learning model using historical shipment data. In some aspects, the historical shipment data may include an origin facility identifier, a destination facility identifier, a waypoint facility identifier, a facility materials identifier, a facility square footage size, an address, a latitude/longitude pair, a carrier identifier, a shipment count, a shipment size, a shipment shape, a shipment volume, a timestamp, geospatial data, facility building data, zoning data, landmark proximity data, electronic logging device data, GPS data, and/or vehicle identifier data.

In general, the present techniques enable location classification of raw shipment data based on the tracking of shipment volumes and location features over time. For example, in some aspects, the machine learning model may be a logistic regression model. In some aspects, the historical shipment data may be a time series data set including multiple historical shipments, each including a respective facility size, a respective facility landmark proximity, a respective shipment shape, and a respective shipment volume. In this case, training the machine learning model may include training the logistic regression model to process a plurality of inputs in the time series to generate a classification prediction.

Locations sending/receiving shipments often differ in size, shape and proximity to landmarks (e.g., interstates, warehouse parks, etc.). Warehouses and distribution centers tend to be large rectangular buildings that are very close to interstates. They also tend to be clustered together, such that there are often multiple rectangular buildings in a group. On the other hand, retail facilities tend to be smaller, more irregular polygonal shaped buildings that are close to residential and commercial zones.

Given these insights, training data derived from maps may be provided to one or more machine learning models, in some aspects. In some aspects, building attributes (e.g., building size, landmark proximity to landmarks, etc) may be retrieved from sources other than maps, such as public websites, private data sets, etc. In some aspects, building attributes may include size information (e.g., square footage) etc. The method 500 may use this size information to classify a location according to likely type, given that even a large retail store (e.g., a Costco) may be approximately 100,000 square feet whereas a distribution center warehouse may be orders of magnitude larger (e.g., millions of square feet).

Information related to shipping and building data may be combined in some modeling techniques. For example, training the logistic regression model may include processing, for a respective shipment at each step in the time series: a shipment size, the proximity of the shipment to another landmark (e.g., an interstate highway exit/interchange), a shipment shape, a shipment volume, etc. By this processing, the logistic regression model may be trained to generate a prediction given de novo/unseen data, such as whether shipment data contained within the de novo data corresponds to a warehouse, or not. In some aspects, shipment contents may be used to classify a location according to the type of business. For example, the method 500 may include training the model to learn relationships between shipment supplier information (e.g., iron alloy) and location type (metal manufacturing).

In some aspects, the method 500 may include processing a plurality of the one or more shipment locations to infer one or more respective operational aspects of one or more shipment locations. For example, the method 500 may include classifying multiple shipments A and B as both being shipments that departed from respective warehouse locations and terminated at respective retail locations. The method 500 may determine a respective transit time for each shipment, and store the transit time in association with the respective warehouse and other information (e.g., distribution center operator, one or more transit carrier, etc.) in an electronic database. Once data relating to several such shipments is stored in the database, the method 500 may compute aggregate statistics over the data.

For example, the method 500 may include computing an average shipment speed per mile for each carrier. The method 500 may compute an average loading time per warehouse/warehouse operator, an average unloading time per carrier, etc. These statistics may enable the present techniques to provide granular comparisons of shipper performance, warehouse performance, 3PL entity performance, etc. The present techniques may be applicable to all forms of logistics delivery/cargo/freight services (e.g., over-the-road, last mile, semi-trailer truck, ocean shipping, rail, and air), whether piloted by humans or semi-/fully autonomous.

The method 500 may include generating a facility classification value selected from the group consisting of: (i) a warehouse facility, (ii) a retail facility, (iii) a weigh station, (iv) a harbor facility or (v) a rail yard facility. In some aspects, other classification values may be included. In some aspects, inputs to the machine learning model may include information that enable the model to learn more specific facility classification types. For example, the method 500 may include training the machine learning model to classify a facility according to one or more North American Industry Classification System (NAICS) classification (e.g., a NAICS Sector 2-digit code, a NAICS Subsector 3-digit code, a NAICS Industry Group 4-digit code, a NAICS NAICS Industry 5-digit code or a NAICS National Industry 6-digit code). In some aspects, inferring a NAICS code of a facility may be based entirely on shipping data.

In some aspects, the method 500 may include displaying, by one or more processors, at least one of the one or more shipment locations including the respective facility classification value on a device of a user. Of course, the method 500 may include displaying other information, as shown above with respect to FIG. 4A, for example.

According to aspects, the classifications output by the machine learning models of the present techniques may be a numeric indicator (e.g., one or more numeric constants each corresponding to a respective different pre-defined class). Each classification may include a respective confidence factor (e.g., 97%) indicating a confidence of the machine learning model in the classification output. The method 500 may communicate the classification results of the present techniques in any suitable manner (e.g., via email, electronic message, text message, etc.). The method 500 may store classification results of the machine learning model(s) in a memory/database.

### Additional Considerations

Although the following text sets forth a detailed description of numerous different aspects, it should be understood that the legal scope of the invention may be defined by the words of the claims set forth at the end of this patent. The detailed description is to be construed as exemplary only and does not describe every possible aspect, as describing every possible aspect would be impractical, if not impossible. One could implement numerous alternate aspects, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various aspects, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. The decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In aspects in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment, or as a server farm), while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect may be included in at least one aspect. The appearances of the phrase “in one aspect” in various places in the specification are not necessarily all referring to the same aspect.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible aspect, as describing every possible aspect would be impractical.

What is claimed is:

1. A computer-implemented method of using machine learning to improve automated shipping facility identification and classification by processing raw shipment data, the method comprising:
receiving, via one or more processors, the raw shipment data;
processing the raw shipment data using a first machine learning model trained using historical shipment data to identify one or more terminal shipment locations;
classifying each of the one or more terminal shipment locations using a second machine learning model trained using the historical shipment data to generate one or more facility classifications; and
storing the one or more facility classifications and the one or more terminal shipment locations in a memory.

2. The computer-implemented method of claim 1, wherein receiving the raw shipment data includes receiving real-time data from one or more vehicles.

3. The computer-implemented method of claim 1, wherein the historical shipment data includes at least one of:
an origin facility identifier, a destination facility identifier, a waypoint facility identifier, a facility materials identifier, a facility square footage size, an address, a latitude/longitude pair, a carrier identifier, a shipment count, a shipment size, a shipment shape, a shipment volume, a timestamp, geospatial data, facility building data, zoning data, landmark proximity data, electronic logging device data, GPS data, or vehicle identifier data.

4. The computer-implemented method of claim 1, wherein the second machine learning model is a logistic regression model; and wherein the historical shipment data is a time series data set including multiple historical shipments, each including a respective facility size, a respective facility landmark proximity, a respective shipment shape, and a respective shipment volume.

5. The computer-implemented method of claim 1, further comprising: processing a plurality of the one or more terminal shipment locations to infer one or more respective operational aspects of the one or more terminal shipment locations.

6. The computer-implemented method of claim 1, wherein the one or more facility classifications are selected from the group consisting of: (i) a warehouse facility, (ii) a retail facility, (iii) a weigh station, (iv) a harbor facility or (v) a rail yard facility.

7. The computer-implemented method of claim 1, further comprising:
displaying, by one or more processors, at least one of the one or more terminal shipment locations including the respective one or more facility classifications on a device of a user.

8. A system for using machine learning for improved automated shipping facility identification and classification, comprising:
a memory storing a set of computer-readable instructions and historical shipment data; and
one or more processors interfaced with the memory, and configured to execute the set of computer-readable instructions to cause the one or more processors to:
receive, via one or more processors, raw shipment data;
process the raw shipment data using a first machine learning model trained using historical shipment data to identify one or more terminal shipment locations;
classify each of the one or more terminal shipment locations using a second machine learning model trained using the historical shipment data to generate one or more facility classifications; and
store the one or more facility classifications and the one or more terminal shipment locations in a memory.

9. The system of claim 8, wherein the one or more processors are configured to execute the set of computer-readable instructions to further cause the one or more processors to:
receive real-time data from one or more vehicles.

10. The system of claim 8, wherein the historical shipment data includes at least one of:
an origin facility identifier, a destination facility identifier, a waypoint facility identifier, a facility materials identifier, a facility square footage size, an address, a latitude/longitude pair, a carrier identifier, a shipment count, a shipment size, a shipment shape, a shipment volume, a timestamp, geospatial data, facility building data, zoning data, landmark proximity data, electronic logging device data, GPS data, or vehicle identifier data.

11. The system of claim 8, wherein the second machine learning model is a logistic regression model; and wherein the historical shipment data is a time series data set including multiple historical shipments, each including a respective facility size, a respective facility landmark proximity, a respective shipment shape, and a respective shipment volume.

12. The system of claim 8, wherein the one or more processors are configured to execute the set of computer-readable instructions to further cause the one or more processors to:
process a plurality of the one or more terminal shipment locations to infer one or more respective operational aspects of the one or more terminal shipment locations.

13. The system of claim 8, wherein the one or more facility classifications are selected from the group consisting of: (i) a warehouse facility, (ii) a retail facility, (iii) a weigh station, (iv) a harbor facility or (v) a rail yard facility.

14. The system of claim 8, wherein the one or more processors are configured to execute the set of computer-readable instructions to further cause the one or more processors to:
display, by one or more processors, at least one of the one or more terminal shipment locations including the respective one or more facility classifications on a device of a user.

15. A non-transitory computer-readable storage medium configured to store instructions executable by a computer processor, the instructions comprising:
instructions for receiving, via one or more processors, raw shipment data; and
instructions for processing, using a first machine learning model trained using historical shipment data, the raw shipment data to identify one or more terminal shipment locations;
instructions for classifying, via one or more processors, each of the one or more terminal shipment locations using a second machine learning model trained using the historical shipment data to generate one or more facility classifications; and
instructions for storing, via one or more processors, the one or more facility classifications and the one or more terminal shipment locations in a memory.

16. The non-transitory computer-readable medium of claim 15, wherein the instructions for receiving the raw shipment data comprise:
instructions for receiving real-time data from one or more vehicles.

17. The non-transitory computer-readable medium of claim 15, wherein the historical shipment data includes at least one of:
an origin facility identifier, a destination facility identifier, a waypoint facility identifier, a facility materials identifier, a facility square footage size, an address, a latitude/longitude pair, a carrier identifier, a shipment count, a shipment size, a shipment shape, a shipment volume, a timestamp, geospatial data, facility building data, zoning data, landmark proximity data, electronic logging device data, GPS data, or vehicle identifier data.

18. The non-transitory computer-readable medium of claim 15, wherein the second machine learning model is a logistic regression model; and wherein the historical shipment data is a time series data set including multiple historical shipments, each including a respective facility size, a respective facility landmark proximity, a respective shipment shape, and a respective shipment volume.

19. The non-transitory computer-readable medium of claim 15, wherein the instructions further comprise:
instructions for processing a plurality of the one or more terminal shipment locations to infer one or more respective operational aspects of the one or more terminal shipment locations.

20. The non-transitory computer-readable medium of claim 15, wherein the instructions further comprise:
instructions for displaying, by one or more processors, at least one of the one or more terminal shipment locations including the respective one or more facility classifications on a device of a user.
